(19) United States
(12) Patent Application Publication
(10) Pub. No.: US 2003/0079219 A1
(43) Pub. Date: Apr. 24, 2003

(54) System for generating utilization profiles and a mobile telephone therefor

(76) Inventor: Peter Lammerhuber, Sulz (AT)

Correspondence Address: Law Offices of Karl Hormann, PO Box 381516, Cambridge, MA, 02238-1516, US

(21) Appl. No.: 10/257,179

(22) PCT Filed: Mar. 14, 2001
(86) PCT No.: PCT/AT01/00072

(51) Int. Cl. H04N 7/16; H04H 9/00; H04M 11/00; H04M 1/00; H04B 1/38

(52) U.S. Cl. 725/14; 725/9; 455/405; 455/557

(57) ABSTRACT

The invention relates to a system for generating utilization profiles (23) concerning the utilization of products (13, 14) that are provided with an identification code (15) which can be read by a scanner. Said system comprises: a large number of mobile telephones (1, 2), each equipped with a clock (12), a scanner (11), a memory (6) and a utilization identification (10). During the scanning of an identification code (15), said telephones save the current time and the scanned identification code to the memory and transmit the contents of the memory (6), together with the utilization identification (10), to a predetermined receiving address, in response to a request signal. Said system also comprises a central computer (4) which is equipped with a database (18) and an output unit (19), said unit saving the contents of the memories (6) and the utilization identifications (10) received from individual mobile telephones (1, 2) to the database (18) and generating the utilization profiles (23) with the help of said database (18).

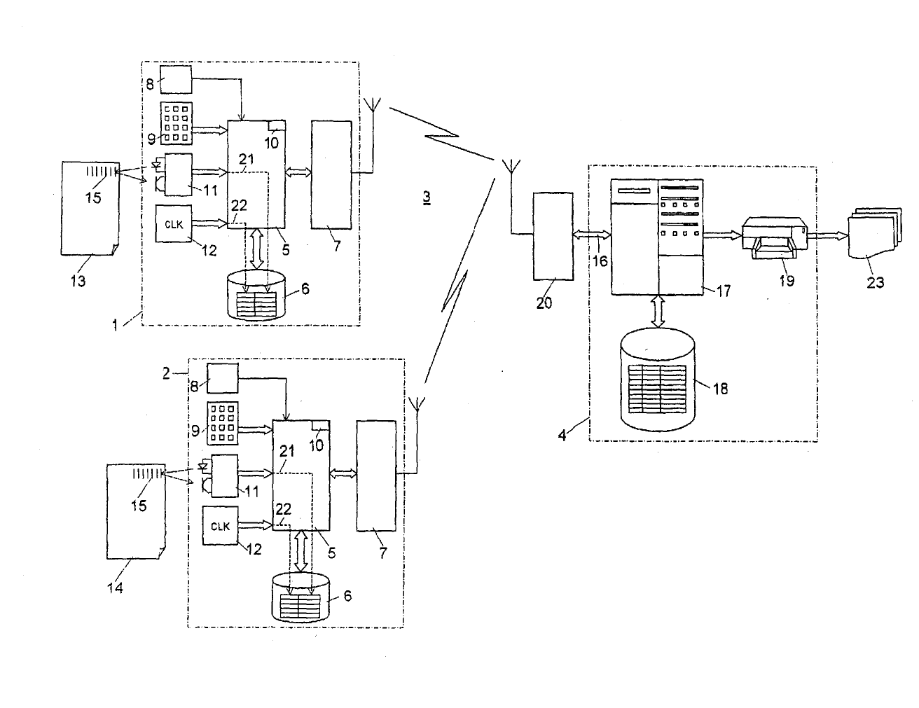

The present invention relates to a system for the production of accurately timed usage profiles about the use of products, such as media products which are provided with a scanner readable identification code, by a plurality of users as well as a mobile telephone particularly suitable for this purpose.

In market research the use of media products is frequently surveyed on the basis of independent samples, referred to as “samples”, or by means of a “panel”, ie a group of people or households which remains unchanged over a relatively long period. The usage behaviour of the sample or panel is captured with the aid of questionnaires which are filled in manually. The psychological expenditure threshold in data capture increases the effect of the scattering of personal cooperation in the sample or panel on the final result.

In connection with consumer products, even in households, fixed installation data capture terminals are known with which the products are measured after purchase. U.S. Pat. No. 4,816,904 discloses a system for the automatic collection of market research data with the aid of capture stations at consumer locations which is interrogated by a central station via fixed network telephone lines. The system is destined to capture television habits and for this purpose has a fixed connection to a television receiver. A special embodiment of the device possesses a bar code reader which is equipped with its own memory and when introduced into a well in the consumer station transfers its collected data to the latter which for its part then transmits the data via the telephone line to the central unit.

The bar code reader is equipped with a memory which can store the produce code and price of approximately 300 different products in order to store all products purchased by consumers on one day. Although the known systems reduce the capture expenditure threshold and hence increase the accuracy of the measured results they do not permit detection of the exact time of use of a product. Equally, it is not possible to draw up a usage profile on the use of repeatedly used products, such as a reserve pack, or of “non-consumable” products, such as a media product, by means of the known systems. By the term “media products” is meant here all types of products of intellectual property which are recorded on a carrier such as print media, audio or video recordings, etc. Such products are also frequently taken along out of doors and used, which use is likewise immeasurable by the known systems.

It is an object of the invention to provide a novel system for producing accurately timed usage profiles about the use of products which overcomes the said disadvantages. This objective is achieved by means of a system of the said type which possesses:

a plurality of mobile telephones each assigned to one user which are moving in a mobile telephone network and are each equipped with a clock, a scanner, a memory and a user identification,

on reading an identification code store at least the current time and the identification code read in the memory and

on an interrogation signal send the contents of the memory together with the user identification via the mobile telephone network to a predetermined receiving address; and

having a central computer for connection to the mobile telephone network to which a receiving address in the mobile telephone network is assigned and which is equipped with a database and an output unit, which stores the memory contents and user identifications received from individual mobile telephones in the database, and produces the usage profiles on the basis of the database by means of the output unit.

At this point it may be noted that mobile telephones equipped with a scanner are disclosed per se in DE-U-298 14 503 or EP-A-0 645 728. DE-U298 14 503 describes the use of such a “scanner handhold” when shopping in the supermarket, in order by way of example to calculate the sum of purchases. In this publication no thought is given to more far-reaching use and in particular utilisation of the radio transmission function of the mobile telephone. The scanner handhold of EP-A-0 645 728 is constructed for the storage of the location and condition of goods in a shop and is connected to the cash register in order to transfer the data to an inventory system.

The invention is based on the recognition that, like wrist watches, mobile telephones have become an everyday object which is carried almost constantly on the person. The invention combines the mobility possibilities of a mobile telephone with an integrated scanner having the possibility of assigning the time which a clock in the mobile telephone affords and the data transmission possibilities to a central collecting point inherent in a mobile telephone. In association with a central computer a completely new system is created in this way which is of surprisingly simple construction, has high user acceptance on account of the low capture expenditure threshold and is continuously available to the user.

At the start and at the end of each use of a product, e.g. on picking up and putting down a periodical, the user passes the scanner once in each case over the product identification code and the starting and finishing time of use together with the identification code are recorded in the memory of the mobile telephone. The mobile telephone can also calculate directly the length of time between the start and end of use and store it together with the identification code. Additionally, via the keys of the mobile telephone the user could enter a qualitative evaluation of what was read or of usage intensity which is stored together with the times and the identification code.

The interrogation signal can be initiated by the user, e.g. by actuating a key on the mobile telephone, whereupon the latter establishes connection to the central computer and transmits the data. Preferably, however, the central computer sends the interrogation signal to the mobile telephone, preferably repeated at intervals, particularly preferably daily. In particular, interrogation may also take place during the night at the low-cost rates. In this way the database in the central computer is continuously updated so that at any time interim measured results can be generated. In a simplified variant of the system according to the invention the mobile telephone with full memory could also be handed over in its entirety at an appropriate collecting point which evaluates the contents of the memory.

A further aspect of the invention consists in the provision of a mobile telephone, which is particularly suitable for such a system, having a clock, a memory and a user identification and distinguishes itself according to the invention in that it is equipped in inherently known manner with a scanner for scanner-readable identification codes and that on reading an identification code stores at least the current time and the identification code read in the memory.

In each case it is particularly useful if the clock is a radio clock which precludes measurement errors due to wrongly set clocks.

The invention is explained in more detail below with reference to an exemplified embodiment illustrated in the drawing. The drawing shows the block diagram of a system according to the invention. Identical elements are labelled by the same reference number.

The figure shows two examples of mobile telephones 1, 2 which are representative of a large number of mobile telephones circulating in a mobile telephone network 3. The mobile telephone network 3 is connected to a central computer 4.

The mobile telephones 1, 2 are each equipped with a microprocessor 5 which is connected to a memory 6 and a high-frequency circuit 7 for communication in the mobile telephone network 3. A display unit 8 and a keypad 9 are connected to the microprocessor 5.

Each mobile telephone 1, 2 is further provided with a user identification 10 which is written permanently, for example, in a ROM memory or on a SIM chip card which is inserted into the mobile telephone.

So far the structure of the mobile telephones 1, 2 corresponds to that of conventional mobile telephones, e.g. in accordance with the GSM standard for a mobile telephone network 3 of the GSM type. Alternatively any other known mobile telephone network standard is also possible.

The mobile telephones 1, 2 are further equipped with a scanner 11 and a clock 12 which are connected to the microprocessor 5. The scanner 11 can be any scanner known in the art, e.g. a CCD camera with output connected to an OCR device. Preferably the scanner 11 is a bar code scanner for bar codes in line with the EAN standard. Two examples of print media products (e.g. periodicals) are illustrated by 13, 14 which carry a scanner-readable identification code 15, e.g. an EAN bar code. The scanners 11 of the mobile telephones 1, 2 in the example shown are directed straight onto the identification codes 15 of the print media products 13, 14.

The central computer 4 comprises an interface 16 for connection to the mobile telephone network 3, a processing unit 17, a database 18 and an output unit 19. The output unit 19 can be of any construction, e.g. in the form of a printer, display screen or in the form of a memory unit, etc. The interface 16 can, for example, lead via a wired telephone or data network to a switching or service centre 20 of the mobile telephone network 3 or itself be constructed as a cell transmitter/receiver of the mobile telephone network 3. For the person skilled in the art it is obvious that the components illustrated may also be distributed or combined in other ways known in the art.

The system illustrated and its components have the following functions.

On reading an identification code 15 of a product 13, 14 with the aid of the scanner 11 the microprocessor 5 of a mobile telephone 1, 2 stores the read identification code 15 together with the current time as provided by the clock 12 in the memory 6. The signal paths from the scanner 11 and the clock 12 to the memory 6 are shown schematically by 21 and 22. It is obvious that these signal paths may also be implemented by means of an appropriate software solution.

The storage process can be initiated automatically by the scanner 11, for example by the latter being constantly active and on capturing a valid identification code 15 causing in conjunction with the microprocessor 5 the interrogation of the time from the clock 12 and storage in the memory 6. Alternatively, this operation could also be initiated by actuating the keypad 9.

The clock 12 is preferably a radio clock which receives its time signal in known manner from a time signal transmitter, e.g. in the long-wave range.

In a preferred application a user moves the scanner 11 of his mobile telephone 1, 2 over the identification code 15 at the start and end of use of a product 13, 14. In this manner data records about the start of use and end of use of a certain product accumulate in the memory 6. Alternatively, on the second capture of the same identification code the microprocessor 5 can automatically recognise the end of use and calculate the length of time of use so that only the length of time of use together with the product identification code 15 is stored in the memory 6. It is obvious to the person skilled in the art that the structure of the memory 6 can be selected accordingly.

At intervals, e.g. once a day, the contents of the memory 6 are transmitted via the mobile telephone network 3 to the central computer 4 which is addressed by a predetermined receiving address in the mobile telephone network. The transmission can be initiated, for example, under time control by the clock 12 in the mobile telephone 1,2 or by actuating the keypad 9 or preferably by an interrogation signal from the central computer 4 which is sent out in the form of a broadcast call or individually to all mobile telephones 1, 2 in the field. The latter respond by transmitting the contents of their memories 6 accompanied in each case by transmission of the user identification 10.

The central computer 4 stores the received memory contents together with the transmitted user identifications 10 in the database 18. Usage profiles 23 can then be prepared from the database 18 in inherently known manner with the aid of the output unit 19, e.g. in the form of printouts. For this purpose all known statistical analysis methods can be used.

On using a product 13, 14 the user can additionally enter via the keypad 9 a qualitative evaluation of the product or his/her intensity of use which is stored in the memory 6 together with the identification code and time. Such data may also count as part of the “memory contents” for the purposes of the present description.

The system presented is suitable in particular for generating usage profiles of repeatedly used products, such as reserve packs and bulk packs of consumer goods (foods, detergents, cleaning agents, etc), or non-consumable products, such as print media products (newspapers, periodicals, etc) and audio and video recordings (CDs, DVDs, video cassettes, etc).

A simplified application consists in capturing the exact time of consumption of single-use consumer goods; such goods are often used in fact only some considerable time after purchase, often only away from home, and in these cases the system presented allows accurately timed capture and allocation.

The system presented has in particular the following advantages:

Low capture expenditure threshold: few active steps on the part of the user are necessary.

Novel level of measurement: measurement and storage at the same time as usage (no longer dependent on the respondent's power of recall).

Broad acceptance of the device: mobile telephones have now become an everyday object whose operation is familiar to everyone.

A device already in use is given additional functionalities. The possibility of free or very low-cost telephone calls is a great inducement for cooperation.

Location-related use in every usage situation.

Flexibility: extendable to surveying other criteria and to all types of products, e.g. fly-sheets, direct mailshots, free newspapers.

Novel data quality: data for every day of the year; data about the duration of use, intensity of use, time of use and number of occasions of use; direct linkage of the data to consumer behaviour.

The invention is naturally not restricted to the embodiments illustrated but rather encompasses all variants and modifications which fall within the scope of the attached claims.

1. System for the production of accurately timed usage profiles about the use of products, such as media products which are provided with a scanner-readable identification code, by a plurality of users, having:
a plurality of mobile telephones (1, 2), each assigned to one user,
which are circulating in a mobile telephone network (3) and are each equipped with a clock (12), a scanner (11), a memory (6) and a user identification (10),
on reading an identification code (15) store at least the current time and the identification code read in the memory (6) and
on an interrogation signal send the contents of the memory (6) together with the user identification (10) via the mobile telephone network (3) to a predetermined receiving address;
and having a central computer (4) for connection to the mobile telephone network (3)
to which a receiving address in the mobile telephone network (3) is assigned and which is equipped with a database (18) and an output unit (19)
which stores the memory contents (6) and user identifications (10) received from individual mobile telephones (1, 2) in the database (18) and produces the usage profiles (23) on the basis of the database (18) by means of the output unit (19).

2. System according to claim 1, characterised in that the central computer (4) sends the interrogation signal to the mobile telephones (1, 2), preferably repeated at intervals, particularly preferably daily.

3. System according to claim 1 or 2, characterised in that the mobile telephone (1, 2) is constructed for key input of a product quality or usage intensity evaluation and for storage of the same together with the time and the identification code.

4. Mobile telephone for a system according to one of claims 1 to 3, which is equipped with a clock, a memory, and a user identification, characterised in that it is equipped in a manner known per se with a scanner (11) for scanner-readable identification codes (15), and in that on reading an identification code (15) it stores at least the current time and the identification code read in the memory (6).

5. Mobile telephone according to claim 4, characterised in that on an interrogation signal it sends the contents of the memory (6) together with the user identification (10) via the mobile telephone network (3) to a predetermined receiving address.

6. Mobile telephone according to claim 4 or 5, characterised in that the clock (12) is a radio clock.

7. Mobile telephone according to one of claims 4 to 6, characterised in that the mobile telephone (1, 2) is constructed for key input of a product quality or usage intensity evaluation and for storing the same together with the time and the identification code.
